(19) United States
(12) Patent Application Publication
(10) Pub. No.: US 2005/0084824 A1
(43) Pub. Date: Apr. 21, 2005

(54) Dental restoration piece and a method for producing a dental restoration piece

(75) Inventor: Hans-Peter Foser, Balzers (LI)

Correspondence Address: John C. Thompson, 69 Grayton Road, Tonawanda, NY, 14150, US

(73) Assignee: Ivoclar Vivadent AG

(21) Appl. No.: 10/762,686

(22) Filed: Jan. 22, 2004

(30) Foreign Application Priority Data
Oct. 17, 2003 (DE) P 103 48 370.5

(51) Int. Cl. A61C 13/08; A61C 13/12

(52) U.S. Cl. 433/212.1; 433/180; 433/197

(57) ABSTRACT

A dental restoration piece is provided which includes a base structure and an over structure which at least partially covers the base structure and which includes hardened bite elements. An interconnecting material interconnects the hardened bite elements with the base structure. In accordance with the inventive method of producing a dental restoration piece, the interconnecting material applied onto the base structure is hardened fully after the hardened bite elements have first been pressed into the still-malleable interconnecting material.

### CROSS-REFERENCE TO RELATED APPLICATIONS

This application claims foreign priority benefits under 35 U.S.C. §119(a)-(d) from German patent application ser. no. P 103 48 370.5 filed Oct. 17, 2003.

### TECHNICAL FIELD

The present invention relates to a dental restoration piece and a method for producing a dental restoration piece.

### BACKGROUND OF THE INVENTION

A known dental restoration piece is disclosed in DE 41 33 690. In connection with this known dental restoration piece, plastic finished partial crowns and bite surfaces are used, which are applied as an integral entirety onto the base structure. After the application of these components onto the base structure, the plastic semi-finished component is hardened via irradiation with ultraviolet, or UV, light, so that a corrected bite surface is thus made available. Such bite surfaces are comparatively soft. At the same time, intensive hand finishing work of such bite surfaces is required to configure the bite surfaces into configurations which simulate the dental structures which are to be restored and the dental restoration piece which is produced by this approach is heavily dependent upon the capability of the dentist or, as the occasion may be, upon the capability of the dental technician, to produce the desired tooth protuberance shape.

Moreover, finished elements for the production of dental restoration pieces are already known as is disclosed, for example, in DE Cl 198 50 451. The approach disclosed in this publication is suitable for the creation of a dental restoration piece, which is configured by covering a metal frame with an opaque covering and thereafter applying thereon a layer of dentin material ceramic. The dental restoration piece precisely establishes the shape of the incisal surfaces. The ceramic layer, or coating, which is configured in approximation of the dentin, must have an exact shape so that no orientation errors can arise. Via the application of two layers or coatings, an aesthetic corresponding result can be achieved; however, a decidedly precise handling of the piece is required in order to assuredly prevent the creation of dental positioning errors.

### OBJECTS AND SUMMARY OF THE INVENTION

The present invention offers a solution to the challenge of providing a dental restoration piece, as well as a method of producing a dental restoration piece, which permits a flexible delivery of dental service via rapid production of the dental restoration piece without posing special hand finishing requirements.

In accordance with the present invention, it is particularly advantageous that at least one bite element—and even more preferably, two bite elements—are made ready as pre-prepared elements as a consequence of which the tooth protuberance shapes can be pre-finished via an industrial process and, thus, to this extent, these tooth protuberance shapes are produced as optimum shapes without manual intervention by a dentist or dental technician.

In this manner, the time for producing an individual optimized bite surface can be significantly reduced and, as well, the dental restoration piece result provides an improved configuration. The dentist need only, after placement of the teeth, for example, in an articulator, work or handle the interconnecting material such that the interconnecting material extends to and communicates in a flush manner with the edges of the bite surface element or the bite surface elements. It is to be understood that, via the making ready of different bite surface elements, different teeth or tooth shapes can be realized as well. For example, a relatively pronounced convex shape of the bite surface elements typically creates a large intercoronary free space.

In accordance with the present invention, it is particularly advantageous that, via the embedding of the bite element in the interconnecting material which is disposed in opposition to the bite element, the advantages of ceramic crowns and plastic crowns are combined: the elastic positioning of the bite element reduces the load on the antagonistic teeth (the teeth in biting opposition to the restoration teeth) while, due to the hardened bite surface, the wear is reduced.

In accordance with the present invention, the interconnecting material can be hardened in place in a surprisingly simple manner. It is possible to undertake a thermal hardening for those regions of the interconnecting material, if they are composed of plastic, provided that they are covered by the bite elements so that the interconnecting material is not polymerized via light irradiation.

While, as a basic consideration, thermal and/or light-hardenable plastics are preferred as the plastic material, a viscous tooth cement can be used in a similar manner, which can be, as the occasion arises, covered as well with a suitable protective layer comprised of, for example, plastic as well.

Surprisingly, in spite of the use of two or three different materials with different heat expansion coefficients, no edge cracks arise. In accordance with the present invention, it is particularly advantageous that the time-consuming firing of the over structure is not required, which permits the cycle time for the production of a dental restoration piece in a dental laboratory to be substantially reduced.

In this connection, it is also advantageous that a dental restoration piece produced in accordance with the present invention can also be polished to a high degree whereby, as well, the transition between the interconnecting material and the bite element can be made ready in a gap-free or crack-free manner.

In accordance with the present invention, it is furthermore advantageous that the relatively soft embedding of the bite element in the soft interconnecting material disposed in opposition to the bite elements significantly reduces the occurrence of fatigue breaks of the hardened bite elements even if, in fact, particularly hard plastic for the bite elements is used or a hard ceramic is used for the bite element.

In accordance with the present invention, it is additionally particularly advantageous that the bite element, which can form a partial bite surface, can be configured in a pre-prepared manner so that a particularly good outer surface quality can be realized.

In accordance with the present invention, it is also possible to use oxide ceramic as well as zirconium oxide for the bite elements which, due to their hardness, would otherwise damage the antagonistic teeth elements but, in accordance with the present invention, do not produce such damage due to the soft embedding of the bite elements.

It is to be understood that the number of bite elements can be adapted in a desired manner to the respective requirements. For example, bisected bite surfaces can be provided for the pre-molars—that is, two bite elements can be applied onto the interconnecting material—while, for the molars, three or four bite elements can be deployed in correspondence with the number of tooth protuberances.

It is particularly advantageous that the tooth protuberance slope can be individually adjustably set. In this manner, the desired occlusion outcome can be optimally set and can be set in a precise manner.

In an advantageous embodiment of the invention, intermediate members can be industrially pre-fabricated and can be anchored in a relatively soft manner via the inventive interconnecting material.

Initially, the required preparation is undertaken for the production of an inventive dental restoration piece. The base structure is formed into a finished condition such as, for example, with a metal coating or formed of complete ceramic or formed in another suitable desired manner. A model is molded of gypsum in a conventional manner. An interconnecting material is applied onto the base structure and, in fact, is comprised of a viscosity which still permits deformation while, however, not permitting deformation of the interconnecting material due solely to the force of gravity. The bite elements are now applied in correspondence with the bite situation and are justified or adjusted in the articulator. In this connection, they are pressed into the interconnecting material mass whereby a fine or precise adjustment can be undertaken.

The hardening of the thus-produced dental restoration piece into its final hardened condition fixes it into its position. The fixing of the dental restoration piece into its position can also be effected by a breaking down of a selected component via a silicone break down agent. There remains only a small free play space, in facing disposition to the preparation border, and the free play space is filled with suitable material such as, for example, light-hardenable plastic, and a hardening out of the thus-applied filler material into its complete hardened condition is then undertaken.

In accordance with the present invention, it is preferable to undertake a securement of the base structure onto a tooth stump. In this manner, a long-lasting strong and shape-fitting support can be realized which permits the correspondingly configured pre-prepared preparation to be harmoniously applied thereunto. Alternatively, it is also possible to secure the base structure onto a tooth peg or, as the occasion arises, onto an attachment element which can itself be anchored in a conventional manner.

Further advantages, details, and features are described in the hereinafter following description of an embodiment of the invention having reference to the figures of the drawings.

### BRIEF DESCRIPTION OF THE FIGURES

FIG. 1 is a schematic perspective view of a model of a lower jaw after the preparation thereof to receive an inventive dental restoration piece;

FIG. 2 is a schematic perspective view of one embodiment of the inventive dental restoration piece during the production thereof;

FIG. 3 is a schematic perspective view of a modification of the one embodiment of the inventive dental restoration piece shown in FIG. 2; and

FIG. 4 is a schematic perspective view of a finished frame base structure for one of the dental restoration pieces shown in FIGS. 2 and 3.

### DETAILED DESCRIPTION

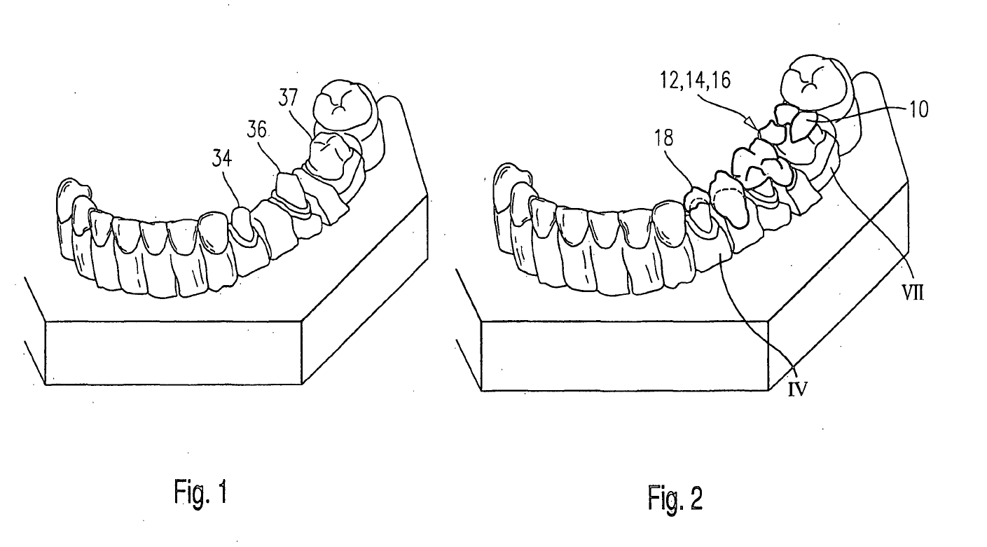

As can be seen in FIG. 1, a dental region which is to be restored—in this example, the lower jaw side tooth region—is initially prepared in a conventional manner whereupon, for example, the incisor teeth 34, 36 and 37 remain. A model is prepared in a conventional manner and is preferably prepared out of super hard gypsum. A base structure is created in a conventional manner based upon the model. The base structure can be disposed into an articulator or, alternatively, can be disposed for fitment testing purposes onto the incisor teeth.

In accordance with the present invention, an interconnecting material 10 is applied, as seen in FIG. 2, onto the base structure (not shown in FIG. 2), wherein the interconnecting material already is in substantially the shape of the subsequent dental restoration. The interconnecting material 10, which is applied onto the base structure, is applied in a still-deformable or malleable condition. The inventive bite elements are now pressed into the interconnecting material 10, whereby, as seen in FIG. 2, three bite elements, 12, 14 and 16 are applied onto the tooth VII.

The advantage of the inventive solution lies in the fact that fine or precise positioning can be performed, even relative to the opposed model disposed in the articulator; due to the inventive semi-permanent condition of the mass which is used as the interconnecting material, the desired position can be obtained without further effort or intervention.

It is to be understood that, via the pressing-in of the bite elements 12-16, a spill-over of material occurs. This can be easily removed during or after completion of the restoration or can be removed at a desired time after the pressing-in of the bite elements.

It is particularly advantageous in connection with the inventive solution that the tooth protuberance slope can be individually adjusted in a very fine or precise manner. In this manner, both steep tooth protuberances or flat tooth protuberances can be configured with the same bite surface elements. The inventory requirements for such bite surface elements of the inventive dental restoration piece are thus very small.

In the embodiment shown in FIG. 2, there is, in addition to the bite elements 12-16 for the molars VII, a bite element 18 for the tooth IV which is adjustably positionable in the same manner in accordance with the present invention.

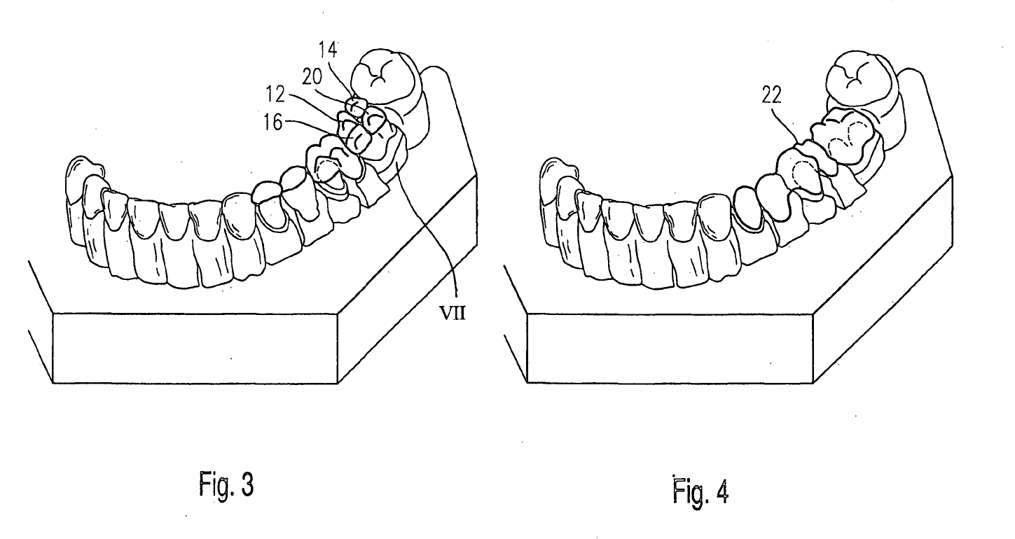

While in the embodiment shown in FIG. 2, a molar VII is provided with the bite elements 12, 14 and 18, a molar VII shown in FIG. 3 is provided with four tooth protuberances 12, 14, 16, and 20—that is, four correspondingly configured bite elements are provided. In this modified embodiment, the positions of the bite elements in-situ are initially maintained via silicone; the assembly of the frame follows thereafter.

It is to be understood that, even if the base structure and over structure must be compatibly configured relative to one another, a certain parallelism is possible in connection with their production, which further saves time. The production of the frame for the base structure can be seen in FIG. 4. In this embodiment, the bite surface elements are fixedly mounted in an operation involving the silicone break down agent 22 and the securement onto the incisor teeth then follows with light-hardenable plastic being applied in a conventional manner to extend up to the preparation borders.

It is to be understood that, as well, a self-hardening plastic can be deployed.

It is further to be understood that the inventive combination of hardened bite surface elements and a soft interconnecting material disposed relative thereto does not foreclose the possibility that additional soft or hard material can be deployed. Thus, for example, a ceramic base structure piece can be connected via teeth cement with another ceramic base structure piece in a conventional manner. The inventive bite surface elements are not limited in this example to an oxide ceramic; it is much more the case that, in lieu thereof, a pre-finished and hardened adjustable plastic can be deployed.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the term “means for” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

1. A dental restoration piece, comprising:
a base structure formed of a selected one of a single member and multiple members;
an over structure which is securable to the base structure in a manner in which the over structure at least partially covers the base structure, at least a portion of the over structure having at least one bite surface being comprised of at least one hardened bite element (12, 14, 16); and
at least one interconnecting material (10) which interconnects the hardened bite elements (12, 14, 16) with the base structure.

2. A dental restoration piece according to claim 1, wherein a selected one of the interconnecting material (10) and a covering material covers the base structure and, preferably, a covering material is disposed on the base structure exteriorly of the hardened bite element (12, 14, 16), such covering material being in an uncovered condition.

3. A dental restoration piece according to claim 2, wherein the selected one of the interconnecting material (10) and the covering material is a plastic and, especially, is a light-hardenable or in-situ hardenable plastic.

4. A dental restoration piece according to claim 1, wherein the interconnecting material is comprised of ceramic.

5. A dental restoration piece according to claim 1, wherein at least one of the bite surface forming bite elements (12, 14, 16, 18) is comprised of a pre-prepared ceramic and, especially, a selected one of an aluminum oxide ceramic, a zirconium oxide ceramic, a glass ceramic, and a mixture of such ceramics.

6. A dental restoration piece according to claim 1, wherein the bite element (12, 14, 16, 18) is comprised of a pre-prepared plastic element, especially a pre-prepared plastic element, preferably a light-hardenable or thermally hardenable plastic element.

7. A dental restoration piece according to claim 1, wherein the base structure comprises a selected one of a metal frame, a metal ceramic frame, a ceramic frame, a plastic frame, and a plastic fiberglass frame.

8. A dental restoration piece according to claim 1, wherein each bite element (12, 14, 16, 18) forms a partial bite surface and, for each tooth for which the bite element (12, 14, 16, and 18) is to form at least a portion of the bite surface of the tooth, a selected one of a set of one bite element (12, 14, 16, 18), a set of two bite elements (12, 14, 16, 18), a set of three bite elements (12, 14, 16, 18), and a set of four bite elements (12, 14, 16, 18) is applied onto positions corresponding to the tooth protuberance locations of the respective tooth and the dental restoration piece is specifically configured for a pre-molar or a molar.

9. A dental restoration piece according to claim 1, and further comprising a lateral free play space of the base structure, which extends between a preparation border of a tooth to be restoratively formed by the dental restoration piece and the bite element (12, 14, 16), the lateral free play space being covered by a selected one of the interconnecting material (10) and a covering material.

10. A dental restoration piece according to claim 9, wherein the lateral free play space extends on two oppositely disposed sides of a selected one of a set of oppositely disposed buccal and lingual sides and a set of oppositely disposed mesial and distal sides and the sides of the respective other one of the set of oppositely disposed sides are covered by lateral extending portions of the over structure.

11. A dental restoration piece according to claim 1, wherein the over structure extends fully over the base structure and is secured thereunto by means of a selected one of the interconnecting material (10) and a covering material which extends up to the preparation border of a tooth to be restoratively formed by the dental restoration piece.

12. A method for producing a dental restoration piece, comprising the steps of:
applying an interconnecting material (10) onto a base structure, the base structure being adapted for being covered at least partially by an over structure which provides the bite forming surface of the dental restoration piece;
pressing, onto the interconnecting material (10) which has been applied onto the base structure, at least one hardened bite element (12, 14, 16) which forms at least a portion of the bite forming region of the over surface in a manner such that the at least one hardened bite element (12, 14, 16) is ultimately oriented for biting operation; and
subjecting the interconnecting material (10) on the base structure to a hardening process by which the interconnecting material (10) is hardened fully.

13. A method for producing a dental restoration piece according to claim 12 further including the step of filling a lateral free play space of the base structure, which extends between a preparation border of a tooth to be restoratively formed by the dental restoration piece and the bite element (12, 14, 16), with a selected one of the interconnecting material (10) and a covering material and hardening the selected one of the interconnecting material (10) and the covering material.
